(19) United States
(12) Patent Application Publication
(10) Pub. No.: US 2018/0145892 A1
(43) Pub. Date: May 24, 2018

(54) METHODS AND DEVICES FOR MONITORING OVERLAPPED IP ADDRESSES IN A MULTI-TENANCY ENVIRONMENT

(71) Applicant: CA, Inc., New York, NY (US)

(72) Inventors: BALRAM REDDY KAKANI, Hyderabad (IN); TRISHUL VARMA VATSAVAI, Hyderabad (IN)

(73) Assignee: CA, Inc., New York, NY (US)

(21) Appl. No.: 15/357,120

(22) Filed: Nov. 21, 2016

(51) Int. Cl. H04L 12/26; H04L 29/08; H04L 29/12

(52) U.S. Cl. CPC H04L 43/04; H04L 61/2007; H04L 67/10

(57) ABSTRACT

A single instance of a network monitoring application running in a service provider network in a multi-tenancy environment identifies a destination tenant that is associated with a destination user device to which a monitoring request is to be sent. The destination user device includes a first user device that is associated with a first tenant or a second user device that is associated with a second tenant in the multi-tenancy environment. A source IP address is associated with the monitoring request, such that the source IP address identifies the destination tenant. The service provider network selectively routes the monitoring request to the destination user device through a network that is associated with the destination tenant based on the source IP address of the monitoring request. Related methods, electronic devices and computer program products are described.

### FIELD

Various embodiments described herein relate to methods, devices, and computer program products and more particularly to methods, devices, and computer program products for a multi-tenancy environment.

### BACKGROUND

Network monitoring applications are important in computer networks to provide functionality such as fault monitoring, identification of slow or failing components, and/or intrusion detection. Metrics such as response time, availability, uptime, etc. of various devices in a network may be measured by network monitoring applications. A network may include a plurality of user devices that are each associated with a tenant. Each tenant may be associated with a plurality of user devices. Each tenant may include a tenant edge device that communicates with a service provider through a service provider edge device.

The service provider may wish to perform network monitoring of the various user devices in the network. However, two user devices associated with two different tenants may have the same IP address, i.e. overlapping IP addresses. Therefore, presently, a single instance of a network monitoring application may have difficulty distinguishing between various user devices that are associated with different tenants but having the same IP address.

### BRIEF SUMMARY

Embodiments described herein include methods, electronic devices, and computer program products that may be configured and/or operable to perform operations in a multi-tenancy environment. In some embodiments, the method includes identifying a destination tenant that is associated with a destination user device to which a monitoring request is to be sent by a single instance of a network monitoring application running in a service provider network in a multi-tenancy environment. The destination user device includes a first user device that is associated with a first tenant or a second user device that is associated with a second tenant in the multi-tenancy environment. The method includes associating a source IP address with the monitoring request. The source IP address identifies the destination tenant. The method includes selectively routing, by the service provider network, the monitoring request to the destination user device through a network that is associated with the destination tenant based on the source IP address of the monitoring request.

In some embodiments, the method includes receiving, from the destination user device, a monitoring response including a destination IP address that is the source IP address of the monitoring request that was sent to the destination user device. The monitoring response may be received responsive to selectively routing the monitoring request to the destination user device.

In some embodiments, the method includes selectively determining that the monitoring response is from the first user device that is associated with the first tenant, based on the destination IP address of the monitoring response. The destination IP address of the monitoring response may include a first destination IP address if the monitoring response is from the first user device. The destination IP address of the monitoring response may include a second destination IP address that is different from the first destination IP address if the monitoring response is from the second user device. An IP address that is associated with the first user device may be the same IP address as an IP address that is associated with the second user device.

In some embodiments, the source IP address may include a first source IP address. The network associated with the first tenant may include a first network. Selectively routing the monitoring request to the destination user device includes applying policy based routing to the monitoring request based on a plurality of policy rules that are associated with the service provider network. The plurality of policies may include a first policy that includes a first rule with a first source IP address that maps to the first network, and/or a second policy that includes a second rule with a second source IP address that maps to a second network that are associated with the second tenant.

In some embodiments, identifying the destination tenant that is associated with the destination user device includes determining a tenant identifier of the destination tenant that is associated with the destination user device and selecting the source IP address for the monitoring request based on the tenant identifier. Selecting the source IP address may include selecting a first source IP address if the tenant identifier is associated with the first tenant, and/or selecting a second source IP address if the tenant identifier is associated with the second tenant, where the first source IP address is different from the second source IP address.

In some embodiments, associating the source IP address with the monitoring request includes selectively associating, by the network monitoring application, the first source IP address with the monitoring request based on determining that the monitoring request is to be sent to the first user device that is associated with the first tenant. Selectively routing the monitoring request to the destination user device may include routing the monitoring request by a service provider edge device that is associated with the service provider network. Identifying the destination tenant that is associated with the destination user device may be based on information stored in the service provider network.

Some embodiments are directed to an electronic device that includes a processor and a memory coupled to the processor and storing computer readable program code that when executed by the processor causes the processor to perform operations including identifying a destination tenant that is associated with a destination user device to which a monitoring request is to be sent by a single instance of a network monitoring application running in a service provider network in a multi-tenancy environment, wherein the destination user device includes a first user device that is associated with a first tenant or a second user device that is associated with a second tenant in the multi-tenancy environment, associating a source IP address with the monitoring request, where the source IP address identifies the destination tenant, selectively routing, by the service provider network, the monitoring request to the destination user device through a network that is associated with the destination tenant based on the source IP address of the monitoring request, and/or receiving, from the destination user device, a monitoring response including a destination IP address that is the source IP address of the monitoring request that was sent to the destination user device.

In some embodiments, the monitoring response is received responsive to the selectively routing the monitoring request to the destination user device. The processor may perform further operations including selectively determining that the monitoring response is from the first user device that is associated with the first tenant, based on the destination IP address of the monitoring response. The destination IP address of the monitoring response may include a first destination IP address if the monitoring response is from the first user device. The destination IP address of the monitoring response may include a second destination IP address that is different from the first destination IP address if the monitoring response is from the second user device. An IP address that is associated with the first user device may be the same IP address as an IP address that is associated with the second user device.

In some embodiments, the source IP address includes a first source IP address. The network associated with the first tenant may include a first network. Selectively routing the monitoring request to the destination user device may cause the processor to perform operations further including applying policy based routing to the monitoring request based on a plurality of policy rules that are associated with the service provider network. The plurality of policies may include a first policy that includes a first rule with a first source IP address that maps to the first network, and a second policy that includes a second rule with a second source IP address that maps to a second network that are associated with the second tenant.

In some embodiments, identifying the destination tenant that is associated with the destination user device may cause the processor to perform operations further including determining a tenant identifier of the destination tenant that is associated with the destination user device, and selecting the source IP address for the monitoring request based on the tenant identifier.

Some embodiments of the present inventive concept include a computer program product including a tangible computer readable storage medium. The computer readable program code embodied in the medium that when executed by a processor of an edge device of a service provider network causes the processor to perform operations including identifying a destination tenant that is associated with a destination user device to which a monitoring request is to be sent by a single instance of a network monitoring application running in a service provider network in a multi-tenancy environment. The destination user device includes a first user device that is associated with a first tenant or a second user device that is associated with a second tenant in the multi-tenancy environment. The operations include associating a source IP address with the monitoring request, where the source IP address identifies the destination tenant and selectively routing, by the service provider network, the monitoring request to the destination user device through a network that is associated with the destination tenant based on the source IP address of the monitoring request.

It is noted that aspects of the disclosure described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

Aspects of the present disclosure are illustrated by way of example and are not limited by the accompanying figures with like references indicating like elements.

FIG. 1 illustrates a multi-tenant network with overlapping IP addresses, according to various embodiments described herein.

FIG. 2 illustrates a multi-tenant network with source IP addresses set by the monitoring application, according to various embodiments described herein.

FIG. 3 is a flowchart of operations by a network monitoring application, according to various embodiments described herein.

FIGS. 4 to 8 are flowcharts illustrating operations for devices/methods according to various embodiments of the present inventive subject matter.

FIG. 9 illustrates an electronic device, according to various embodiments described herein.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Various embodiments described herein may arise from a recognition that the network monitoring application may need to distinguish between user devices belonging to different tenants that may have the same the IP address. The network monitoring application would need a mechanism for distinguishing user devices with the same IP addresses and/or overlapping IP addresses, without altering software in the tenant edge devices and/or in the user devices.

Various embodiments described herein can overcome this potential problem of distinguishing between user devices that have the same IP address in different tenants by providing different source IP addresses from the service provider edge for data packets directed to the different user devices. Network data packets from the various user devices will be received by the network monitoring application with different destination IP addresses, thereby identifying the tenant from which the packet was received. Using different source IP addresses provides the advantage of no changes to tenant software or user device software to accommodate the strategy described herein. Furthermore, legacy systems may use multiple instances of the network monitoring application, such as one instance per tenant. As described herein, using different source IP addresses to distinguish different user devices with the same IP address would reduce and/or eliminate the need to for multiple instances of the network monitoring software, providing savings in processing power, savings in memory, reducing maintenance, and/or improving latency.

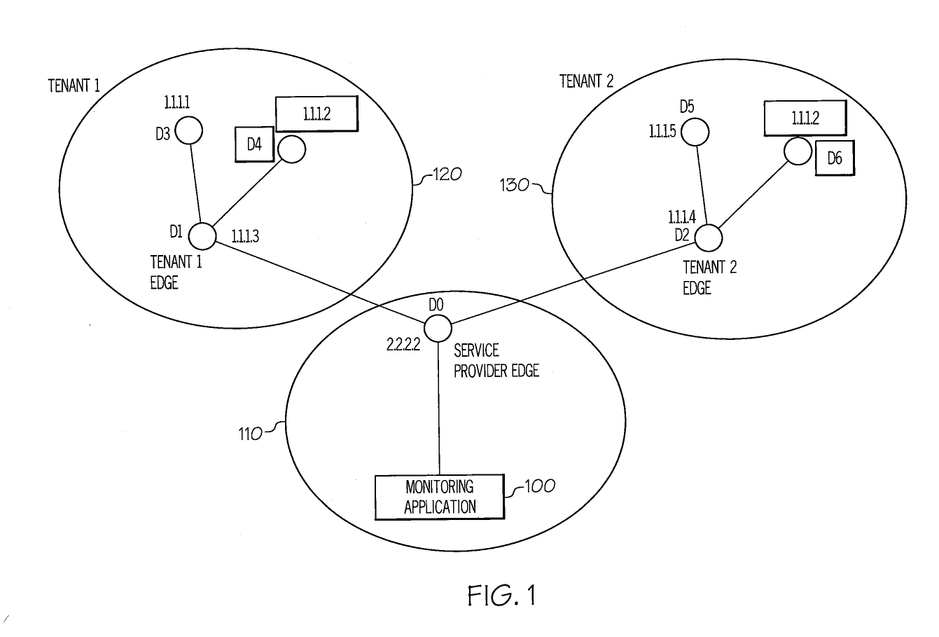

FIG. 1 illustrates a communications network architecture that includes a scenario with multiple tenants that have user devices that have the same IP address. Referring now to FIG. 1, the communication network includes a service provider network 110 that has devices that are in communication with two different tenant networks 120, 130. As used herein, the terms “tenant” and “tenant network” may be used to refer to a grouping of a plurality of users related to a customer or a network associated with the customer. The service provider network includes a network monitoring application 100 that provides fault monitoring, identification of slow or failing components, and/or intrusion detection of user devices in the communications network. Metrics such as response time, availability, device uptime, etc. of various devices in a network may be collected by the networking monitoring application 100. A service provider edge device D0 in the service provider network 110 may provide an interface to other networks such as tenant network 120 and/or tenant network 130. In some embodiments, the monitoring application 100 may be integrated with and/or running on the same device and/or the same processor as the service provider edge device D0. Service provider edge device D0 may include routers, switches, end-hosts, gateway, and/or other networking elements. Service provider edge device D0 may communicate with tenant edge device D1 when accessing user devices D3 and/or D4 in tenant network 120. Likewise, service provider edge device D0 may communicate with tenant edge device D2 when accessing user devices D5 and/or D6 in tenant network 130. In some cases, user device D4 in tenant network 120 may have the same IP address 1.1.1.2 as user device D6 in tenant network 130.

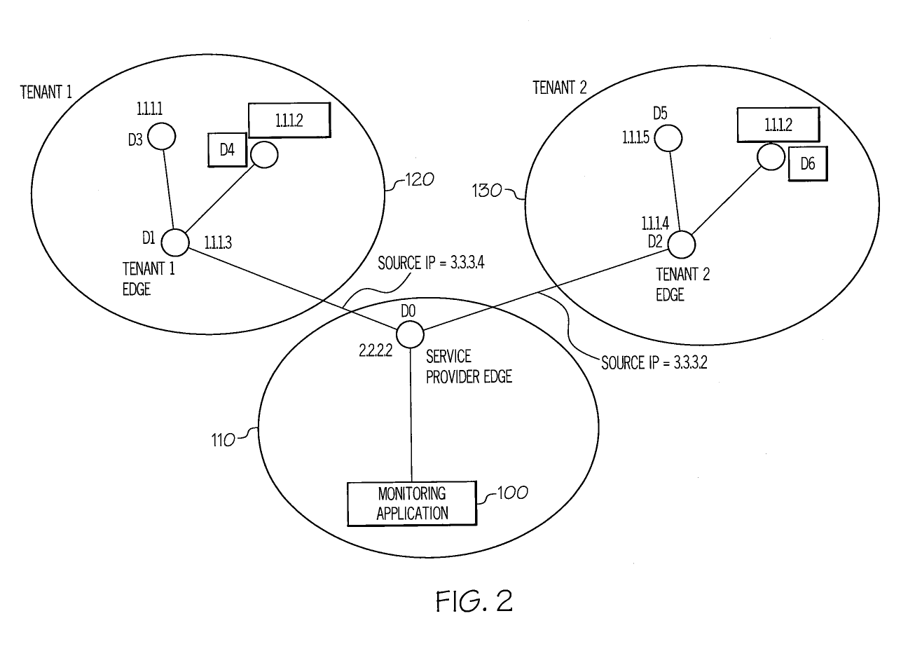

FIG. 2 illustrates using different source IP addresses by the monitoring application in the communications network that includes multiple tenants that have user devices that have the same IP address. Referring now to FIG. 2, a single instance of the network monitoring application 100 may be running in the service provider network 110 that serves a multi-tenancy environment. The network monitoring application 100 identifies a destination tenant that is associated with a destination user device to which a monitoring request is to be sent by the single instance of a network monitoring application 100. The destination user device may be a first user device D6 that is associated with a first tenant 130 or a second user device D4 that is associated with a second tenant 120 in the multi-tenancy environment. The monitoring application 100 associates a source IP address that identifies the destination tenant with the monitoring request. For example, if the destination user device for the monitoring request is user device D6, then the monitoring device may use source IP address 3.3.3.2 whereas if the destination user device for the monitoring request is user device D4, then the monitoring device may use source IP address 3.3.3.4. Even if user devices D4 and D6 have the same destination IP address of 1.1.1.2, as illustrated in FIG. 2, the monitoring application distinguishes the monitoring request to be sent to the user devices D4 or D6 by using a different source IP address. Therefore, two different user devices associated with different tenants but having the same IP address are distinguished from one another by the monitoring device. In some embodiments, the use of different source IP addresses may be referred to as “IP aliasing”. For the destination user device, the monitoring application may look up the associated tenant in a service provider database that was populated when a user device such as D6 was added to the network. The network monitoring application may use a property such as a tenant identifier to distinguish between different tenants, which may be included in the service provider database. This procedure may be referred to as “tenant discrimination”.

Once the proper source IP address is set by the monitoring application 100 for the monitoring request, the service provider network 110, by way of a service provider edge device D0, may selectively route the monitoring request to the destination user device through a network that is associated with the destination tenant based on the source IP address of the monitoring request. In the ongoing example, the source IP address for the monitoring request is 3.3.3.2 and the destination IP address is 1.1.1.2. The service provider edge device D0 may recognize that the source IP address 3.3.3.2 is associated with the second tenant 130. Thus, the monitoring request that has a source IP address of 3.3.3.2 would be routed by service provider edge device D0 to the second tenant's edge device D2, which, in turn, would forward the monitoring request to user device D6, which has an IP address of 1.1.1.2.

Responsive to receiving the monitoring request, user device D6 may send a monitoring response to the monitoring application 100. The destination IP address of the monitoring response from the user device D6 may be the source IP address of the monitoring request that was previously sent to the user device D6, i.e. the destination IP address of the monitoring response is 3.3.3.2. The source IP address of the monitoring response would be the IP address of user device D6, i.e. 1.1.1.2. The second tenant edge device D2 that is associated with the user device D6 may have learned the routing to the service provider edge based on the previously received monitoring request. As such, based on the destination IP address of the monitoring response, the second tenant edge device D2 may route the monitoring response to the service provider edge device D0, which forwards it to the monitoring application 100. According to the example embodiment of FIG. 2, the monitoring application 100 may receive packets destined for IP address 3.3.3.4 or 3.3.3.2. The monitoring application 100 determines the originating user device of the monitoring response based on the destination IP address of the monitoring response. In the ongoing example, monitoring application 100 may determine that the monitoring response is from user device D6, based on the destination IP address of 3.3.3.2 and the source IP address of 1.1.1.2. If the source IP address is 1.1.1.2 but the destination IP address of the monitoring response is 3.3.3.4, then the monitoring application 100 would recognize that the monitoring response is from user device D4.

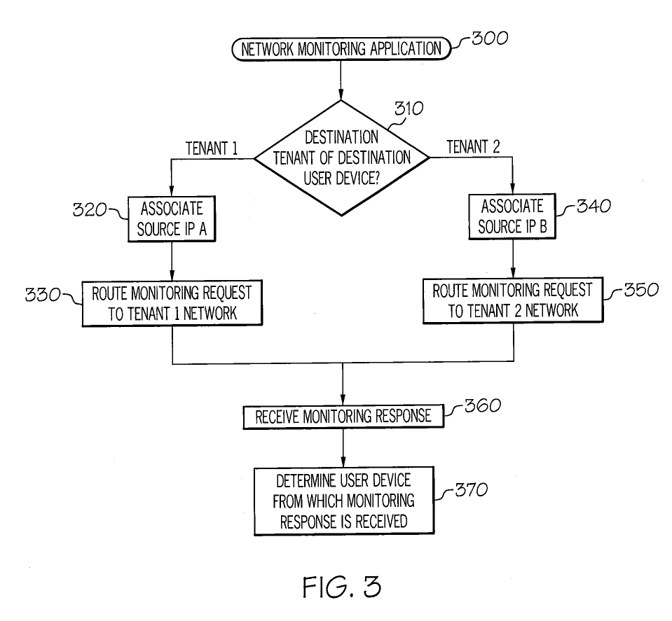

FIG. 3 is a flowchart of operations by the monitoring application 100 of FIG. 2. At block 300, a network monitoring application may be running in the service provider network 110 of FIG. 2. If the network monitoring application needs to send a monitoring request to a user device, the network monitoring application may determine the destination tenant of the destination user device, at block 310. If tenant 1 is associated with the destination user device, then the monitoring application associates a source IP address A, at block 320, to the monitoring request. If tenant 2 is associated with the destination user device, then the monitoring application associates a source IP address B, at block 340, to the monitoring request. A monitoring request with source IP address A is routed by the service provider edge device to tenant 1's network, at block 330. A monitoring request with source IP address B is routed by the service provider edge device to tenant 2's network, at block 350. In response to the monitoring request, the monitoring application may receive a monitoring response from the user device, at block 360. In some embodiments, the user device may send a single monitoring request that causes the user device to send monitoring information periodically, or at other intervals to the monitoring application. Upon receipt of a monitoring response, the monitoring application determines from which user device that the monitoring response was received, at block 370.

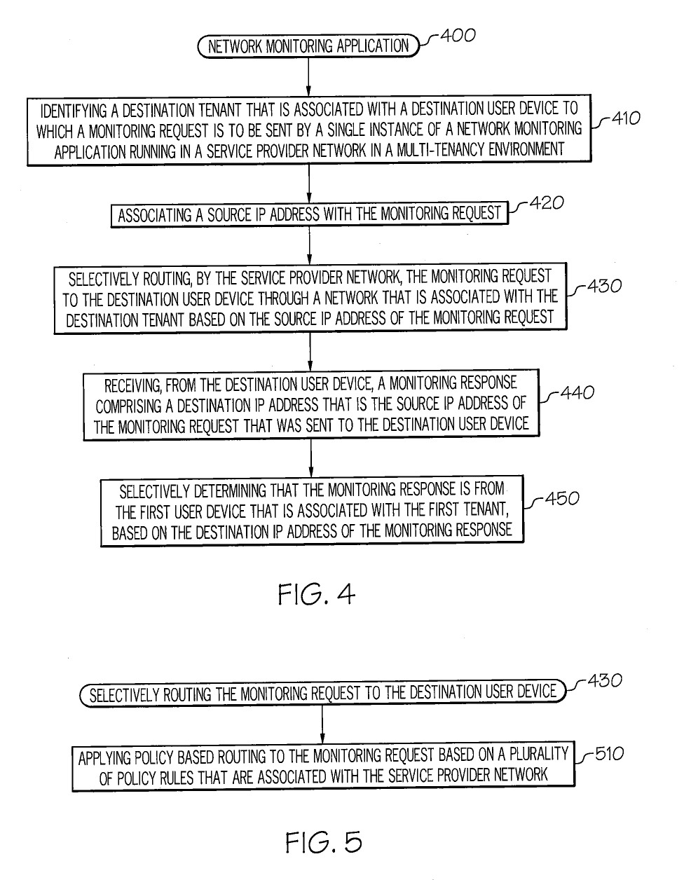

FIGS. 4 to 8 are flowcharts illustrating operations for devices/methods, according to some embodiments of the present inventive concepts. Referring now to FIG. 4, at block 400, a network monitoring application may be running in the service provider network 110 of FIG. 2. A single instance of the network monitoring application running in the service provider network in a multi-tenancy environment may identify a destination tenant that is associated with a destination user device to which a monitoring request is to be sent, at block 410. The destination user device may be one of a first user device that is associated with a first tenant or a second user device that is associated with a second tenant in the multi-tenancy environment. The monitoring application may associate a source IP address with the monitoring request, such that the source IP address identifies the destination tenant, at block 420. The service provider network may selectively route the monitoring request to the destination user device through a network that is associated with the destination tenant based on the source IP address of the monitoring request, at block 430.

Still referring to FIG. 4, in some embodiments, the monitoring application may receive, from the destination user device, a monitoring response that includes a destination IP address that is the source IP address of the monitoring request that was sent to the destination user device, at block 440. The monitoring response may be received responsive to the selectively routing the monitoring request to the destination user device. In some embodiments, the monitoring application may selectively determine that the monitoring response is from the first user device that is associated with the first tenant, based on the destination IP address of the monitoring response, at block 450. The destination IP address of the monitoring response may include a first destination IP address if the monitoring response is from the first user device, or the destination IP address of the monitoring response may include a second destination IP address that is different from the first destination IP address if the monitoring response is from the second user device. An IP address that is associated with the first user device may be the same IP address as an IP address that is associated with the second user device.

Referring now to FIG. 5, the source IP address may include a first source IP address and the network associated with the first tenant may include a first network. In some embodiments, selectively routing the monitoring request to the destination user device of block 430 may include applying policy based routing to the monitoring request based on a multiple of policy rules that are associated with the service provider network, at block 510. The multiple of policies may include a first policy that includes a first rule with a first source IP address that maps to the first network, and a second policy that includes a second rule with a second source IP address that maps to a second network that are associated with the second tenant.

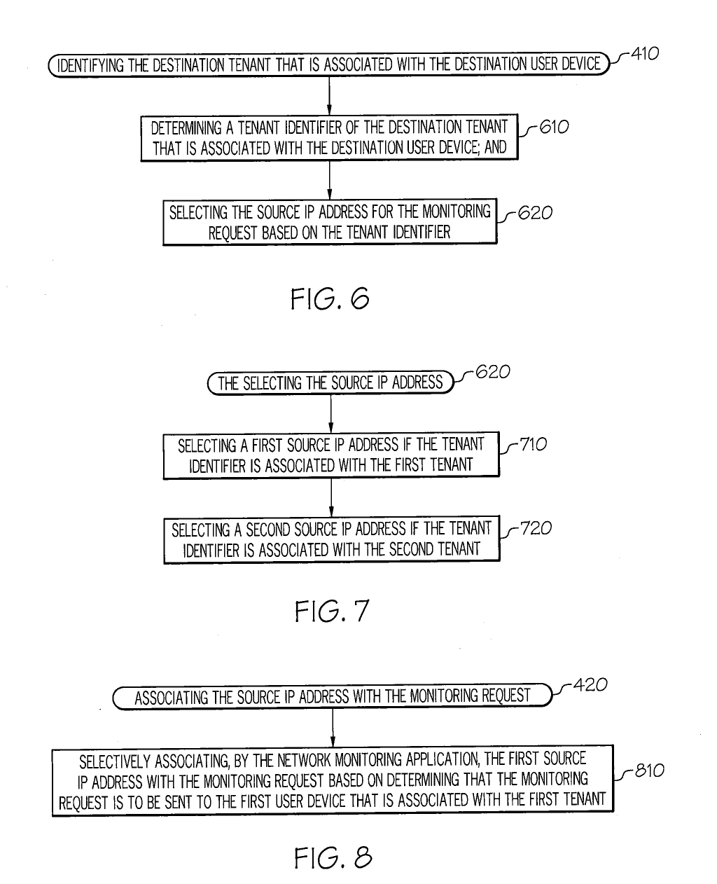

Referring now to FIG. 6, in some embodiments, identifying the destination tenant that is associated with the destination user device of block 410 may include determining a tenant identifier of the destination tenant that is associated with the destination user device, at block 610 and/or may include selecting the source IP address for the monitoring request based on the tenant identifier, at block 620.

Referring now to FIG. 7, in some embodiments, selecting the source IP address at block 620 of FIG. 6 may include selecting a first source IP address if the tenant identifier is associated with the first tenant, at block 710. Selecting the source IP address at block 620 of FIG. 6 may include selecting a second source IP address if the tenant identifier is associated with the second tenant, at block 720. The first source IP address may be different from the second source IP address in order to distinguish the different tenants that have user devices with the same IP addresses.

Referring now to FIG. 8, in some embodiments, associating the source IP address with the monitoring request of block 420 of FIG. 4 may include selectively associating, by the network monitoring application, the first source IP address with the monitoring request based on determining that the monitoring request is to be sent to the first user device that is associated with the first tenant, at block 810. Selectively routing the monitoring request to the destination user device may include routing the monitoring request by a service provider edge device that is associated with the service provider network. In some embodiments, identifying the destination tenant that is associated with the destination user device may be based on information stored in the service provider network.

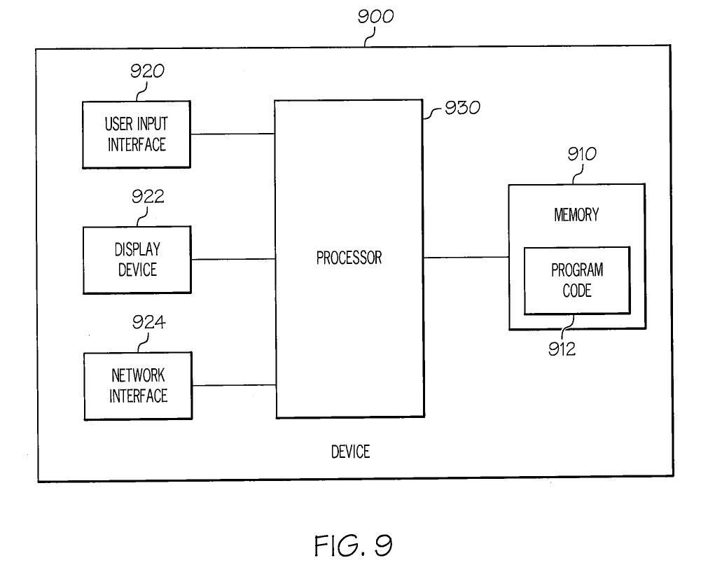

FIG. 9 is a block diagram of an electronic device 900 configured according to some embodiments. The electronic device 900 may include the service provider edge device D0 and/or the network monitoring application 100 of FIG. 2. Referring to FIG. 9, the electronic device 900 includes a processor 930, a memory 910, and a network interface 924 which may include a radio access network transceiver and/or a wired network interface (e.g., Ethernet interface). The radio access network transceiver can include, but is not limited to, a LTE or other cellular transceiver, WLAN transceiver (IEEE 802.11), WiMax transceiver, or other radio communication transceiver configured with the service provider network 110 of FIG. 2.

The processor 930 may include one or more data processing circuits, such as a general purpose and/or special purpose processor (e.g., microprocessor and/or digital signal processor) that may be collocated or distributed across one or more networks. The processor 930 is configured to execute computer program code 912 in the memory 910, described as a non-transitory computer readable medium, to perform at least some of the operations described herein as being performed by an electronic device. The computer program code 912 when executed by the processor 930 causes the processor 930 to perform operations in accordance with one or more embodiments disclosed herein for the electronic device 900. The electronic device 900 may further include a user input interface 920 (e.g., touch screen, keyboard, keypad, etc.) and a display device 922.

As described herein, a combination of tenant discriminators based on source IP addresses, IP aliasing, and policy based routing may be used to address the issue of overlapping addresses across multiple tenants in a multi-tenancy network to facilitate using a single network monitoring instance. The inventive concepts described herein provide an advantage over legacy systems that either use multiple monitoring agents or use additional software installed in the tenant network. As described herein, information available in the service provider network is used to distinguish user devices with overlapping IP addresses. The monitoring application described herein may use less overhead and may offer easier ways to detect outages in the network.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
identifying a destination tenant that is associated with a destination user device to which a monitoring request is to be sent by a single instance of a network monitoring application running in a service provider network in a multi-tenancy environment, wherein the destination user device comprises a first user device that is associated with a first tenant or a second user device that is associated with a second tenant in the multi-tenancy environment;
associating a source IP address with the monitoring request, wherein the source IP address identifies the destination tenant; and
selectively routing, by the service provider network, the monitoring request to the destination user device through a network that is associated with the destination tenant based on the source IP address of the monitoring request.

2. The method of claim 1, further comprising:
receiving, from the destination user device, a monitoring response comprising a destination IP address that is the source IP address of the monitoring request that was sent to the destination user device.

3. The method of claim 2, wherein the monitoring response is received responsive to selectively routing the monitoring request to the destination user device.

4. The method of claim 2, further comprising:
selectively determining that the monitoring response is from the first user device that is associated with the first tenant, based on the destination IP address of the monitoring response.

5. The method of claim 4,
wherein the destination IP address of the monitoring response comprises a first destination IP address if the monitoring response is from the first user device, and
wherein the destination IP address of the monitoring response comprises a second destination IP address that is different from the first destination IP address if the monitoring response is from the second user device.

6. The method of claim 1, wherein an IP address that is associated with the first user device is a same IP address as an IP address that is associated with the second user device.

7. The method of claim 1,
wherein the source IP address comprises a first source IP address,
wherein the network associated with the first tenant comprises a first network,
wherein the selectively routing the monitoring request to the destination user device comprises applying policy based routing to the monitoring request based on a plurality of policy rules that are associated with the service provider network, and
wherein the plurality of policies comprise a first policy that comprises a first rule with a first source IP address that maps to the first network, and a second policy that comprises a second rule with a second source IP address that maps to a second network that are associated with the second tenant.

8. The method of claim 1, wherein the identifying the destination tenant that is associated with the destination user device comprises:
determining a tenant identifier of the destination tenant that is associated with the destination user device; and
selecting the source IP address for the monitoring request based on the tenant identifier.

9. The method of claim 8, wherein the selecting the source IP address comprises:
selecting a first source IP address if the tenant identifier is associated with the first tenant; and
selecting a second source IP address if the tenant identifier is associated with the second tenant,
wherein the first source IP address is different from the second source IP address.

10. The method of claim 9, wherein the associating the source IP address with the monitoring request comprises:
selectively associating, by the network monitoring application, the first source IP address with the monitoring request based on determining that the monitoring request is to be sent to the first user device that is associated with the first tenant.

11. The method of claim 1, wherein the selectively routing the monitoring request to the destination user device comprises routing the monitoring request by a service provider edge device that is associated with the service provider network.

12. The method of claim 1, wherein the identifying the destination tenant that is associated with the destination user device is based on information stored in the service provider network.

13. An electronic device, comprising:
a processor; and
a memory coupled to the processor and storing computer readable program code that when executed by the processor causes the processor to perform operations comprising:
identifying a destination tenant that is associated with a destination user device to which a monitoring request is to be sent by a single instance of a network monitoring application running in a service provider network in a multi-tenancy environment, wherein the destination user device comprises a first user device that is associated with a first tenant or a second user device that is associated with a second tenant in the multi-tenancy environment;
associating a source IP address with the monitoring request, wherein the source IP address identifies the destination tenant;
selectively routing, by the service provider network, the monitoring request to the destination user device through a network that is associated with the destination tenant based on the source IP address of the monitoring request; and
receiving, from the destination user device, a monitoring response comprising a destination IP address that is the source IP address of the monitoring request that was sent to the destination user device.

14. The electronic device of claim 13, wherein the monitoring response is received responsive to selectively routing the monitoring request to the destination user device.

15. The electronic device of claim 13, wherein the processor performs operations further comprising selectively determining that the monitoring response is from the first user device that is associated with the first tenant, based on the destination IP address of the monitoring response.

16. The electronic device of claim 15,
wherein the destination IP address of the monitoring response comprises a first destination IP address if the monitoring response is from the first user device, and
wherein the destination IP address of the monitoring response comprises a second destination IP address that is different from the first destination IP address if the monitoring response is from the second user device.

17. The electronic device of claim 13, wherein an IP address that is associated with the first user device is a same IP address as an IP address that is associated with the second user device.

18. The electronic device of claim 13,
wherein the source IP address comprises a first source IP address,
wherein the network associated with the first tenant comprises a first network,
wherein the selectively routing the monitoring request to the destination user device causes the processor to perform operations further comprising applying policy based routing to the monitoring request based on a plurality of policy rules that are associated with the service provider network, and
wherein the plurality of policies comprise a first policy that comprises a first rule with a first source IP address that maps to the first network, and a second policy that comprises a second rule with a second source IP address that maps to a second network that are associated with the second tenant.

19. The electronic device of claim 13, wherein the identifying the destination tenant that is associated with the destination user device causes the processor to perform operations further comprising:
determining a tenant identifier of the destination tenant that is associated with the destination user device; and
selecting the source IP address for the monitoring request based on the tenant identifier.

20. A computer program product, comprising:
a tangible computer readable storage medium comprising computer readable program code embodied in the medium that when executed by a processor of an edge device of a service provider network causes the processor to perform operations comprising:
identifying a destination tenant that is associated with a destination user device to which a monitoring request is to be sent by a single instance of a network monitoring application running in a service provider network in a multi-tenancy environment, wherein the destination user device comprises a first user device that is associated with a first tenant or a second user device that is associated with a second tenant in the multi-tenancy environment;
associating a source IP address with the monitoring request, wherein the source IP address identifies the destination tenant; and
selectively routing, by the service provider network, the monitoring request to the destination user device through a network that is associated with the destination tenant based on the source IP address of the monitoring request.
